(19) United States
(12) Patent Application Publication
(10) Pub. No.: US 2008/0113212 A1
(43) Pub. Date: May 15, 2008

(54) Skin having enameled metal structure for parallel device

(75) Inventor: Heng-Yen Liu, Jhudong Township (TW)

Correspondence Address: TROXELL LAW OFFICE PLLC, 5205 LEESBURG PIKE, SUITE 1404, FALLS CHURCH, VA, 22041, US

(73) Assignee: Hocheng Corporation, Taipei (TW)

(21) Appl. No.: 11/716,038

(22) Filed: Mar. 9, 2007

(30) Foreign Application Priority Data
Nov. 9, 2006 (TW) 095219807

(51) Int. Cl. C03C 29/00

(52) U.S. Cl. 428/632

(57) ABSTRACT

A skin is coated on a shell of a parallel device. With the skin, the parallel device becomes more beautiful. The skin is made of enamel. Hence, the shell is kept from scrape and corrosion. At the same time, the shell is more easily cleaned.

### FIELD OF THE INVENTION

The present invention relates to a skin for parallel device; more particularly, relates to beautifying appearance of parallel device accompanying a sense of feel with an enameled metal structure and thus being prevented from scrape and corrosion with easy cleaning.

### DESCRIPTION OF THE RELATED ARTS

A skin for parallel device is generally made of plastics, acrylon nitrile butadiene styrene (ABS) or polycarbonate (PC). But, a shell made of the above materials is not strong and not sustainable to a sudden falling-down. Besides, it is easily scraped and corroded; and is easily getting dirty and is hard to be cleaned. In addition, the shell can only change its shape and color, so that its appearance looks dummy and rough without beauty and sense of feel.

Therefore, a prior art is invented, called “A parallel device skin with fiber lines”, comprising a mouse shell having an inlaying area; and a fiber knitting having a size fitting to the inlaying area to be in layed. The prior art improved in sustain ability to a falling-down and in appearance with sense of feel. Yet, the structure is still weak, easily scraped and corroded. Hence, the prior arts do not fulfill users' requests on actual use.

### SUMMARY OF THE INVENTION

The main purpose of the present invention is to beautify appearance of parallel device accompanying a sense of feel with an enameled metal structure and thus to be prevented from scrape and corrosion with easy cleaning.

To achieve the above purpose, the present invention is a skin having an enameled metal structure for parallel device, comprising a metal base layer; an image area on a surface of the metal base layer; and a coating layer made of a glass material and a metal oxide on the metal base layer and the image area, where the skin for parallel device further comprises a shell having a sunk are a on a surface of the shell to be deposed with the skin for parallel device. Accordingly, a novel skin having an enameled metal structure for parallel device is obtained.

### BRIEF DESCRIPTION OF THE DRAWINGS

The present invention will be better understood from the following detailed descriptions of the preferred embodiments according to the present invention, taken in conjunction with the accompanying drawings, in which

FIG. 1 is the perspective view showing the first preferred embodiment according to the present invention;

FIG. 2 is the explosive view of the first preferred embodiment;

FIG. 3 is the sectional view of the first preferred embodiment;

FIG. 4 is the perspective view showing the second preferred embodiment;

FIG. 5 is the perspective view showing the third preferred embodiment;

FIG. 6 is the perspective view showing the fourth preferred embodiment;

FIG. 7 is the explosive view of the fourth preferred embodiment;

FIG. 8 is the section a view of the fourth preferred embodiment;

FIG. 9 is the perspective view showing the fifth preferred embodiment;

FIG. 10 is the perspective view showing the sixth preferred embodiment;

FIG. 11 is the explosive view showing the seventh preferred embodiment; and

FIG. 12 is the sectional view of the seventh preferred embodiment.

### DESCRIPTION OF THE PREFERRED EMBODIMENTS

The following descriptions of the preferred embodiments are provided to understand the features and the structures of the present invention.

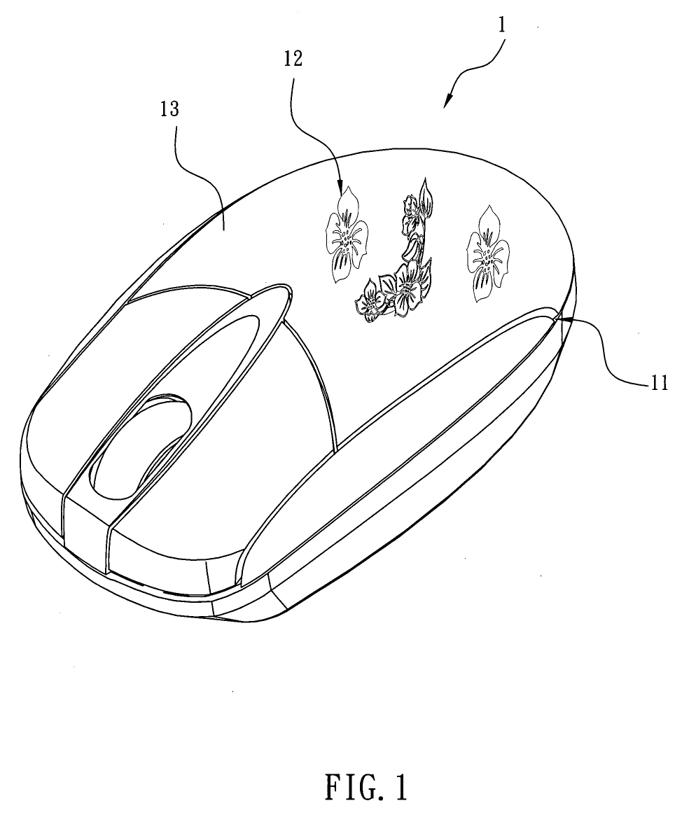

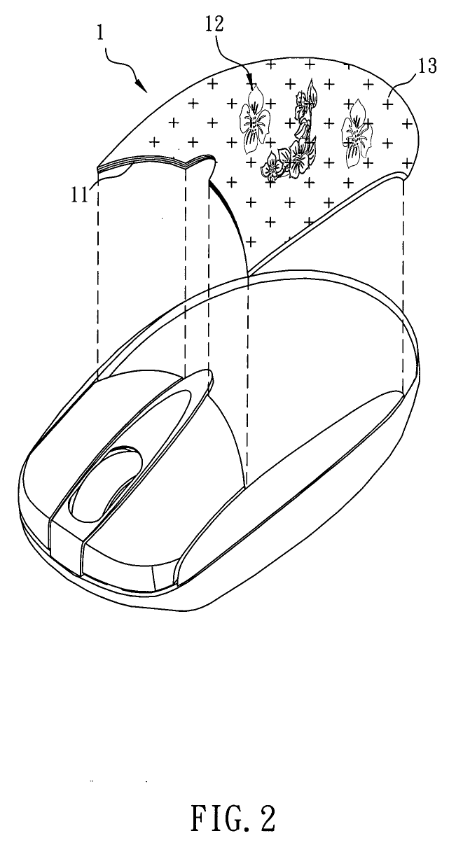

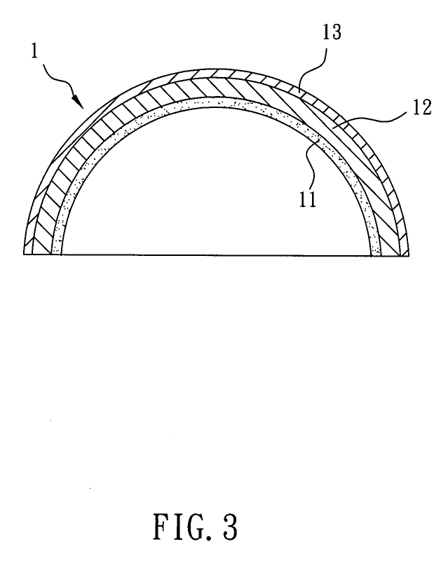

Please refer to FIG. 1 to FIG. 5, which are a perspective, an explosive and a sectional views showing a first preferred embodiment; and perspective views showing a second and a third preferred embodiments, according to the present invention. As shown in the figures, the present invention is a skin 1 having an enameled metal structure for parallel device, comprising a metal base layer 11, an image area 12 and a coating layer 13, where a parallel device obtains a beautiful appearance and a sense of feel with the skin; and the parallel device is thus prevented from scrape and corrosion and is easily cleaned.

The metal base layer 11 is made of copper.

The image area 12 is flat or is 3D (three-dimensional) hollowed-out; and is deposed on a surface of the metal base layer 11.

The coating layer 13 is deposed on the metal base layer 11 and the image area 12; and is made of a glass material and a metal oxide. The glass material is made by mixing with a borate or a silicate; and the glass material has more than 25 percents (% of boron oxide.

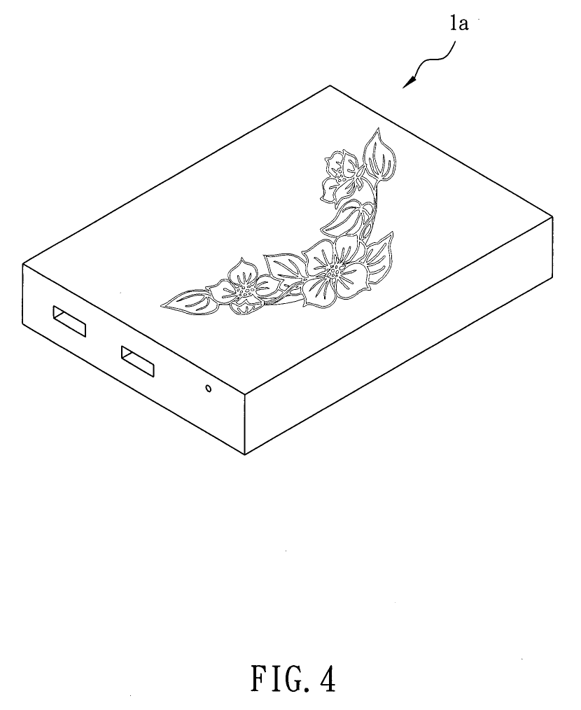

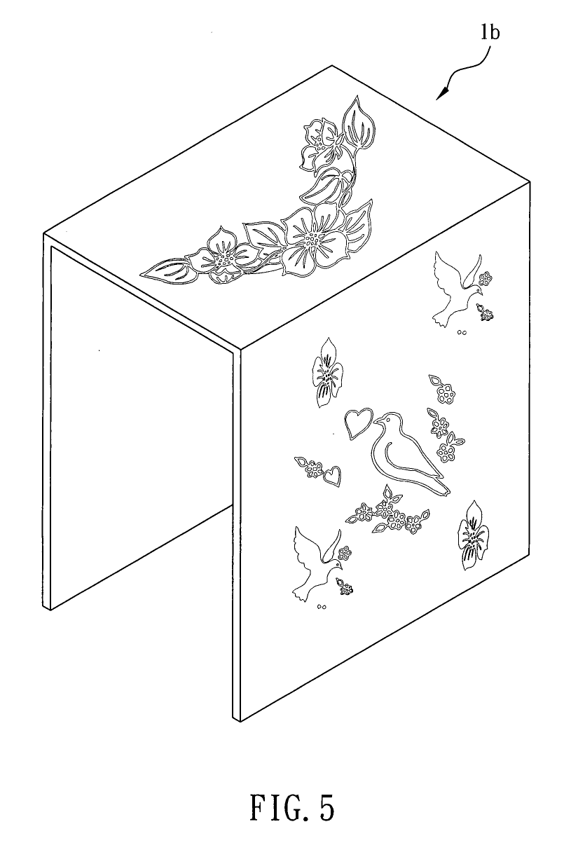

When fabricating the skin 1, the metal base layer 11 is formed into the shape of the skin 1 for parallel device, like a skin for a mouse. Then the image area 12 is hollowed out with a copper wire or a wire of other metal; and the image area 12 designed by the wire is burnt at 900 Celsius degrees (° C.) to be firmly welded on the metal base layer 11. Then the glass material is filled into the hollowed-out image area 12 and is burnt at 750° C. to 800° C. to form a coating layer 13 above the metal base layer 11 and the image area 12. In the end, a polish is done as required. Thus, a skin having an enameled metal structure for parallel device is obtained. Besides, the skin is not only for a mouse, but also for an external hard disk 1 a (as shown in FIG. 4), a computer main frame 1b (as shown in FIG. 5), a USB (universal serial bus) hub, a network device and a DVD (digital versatile disc) player.

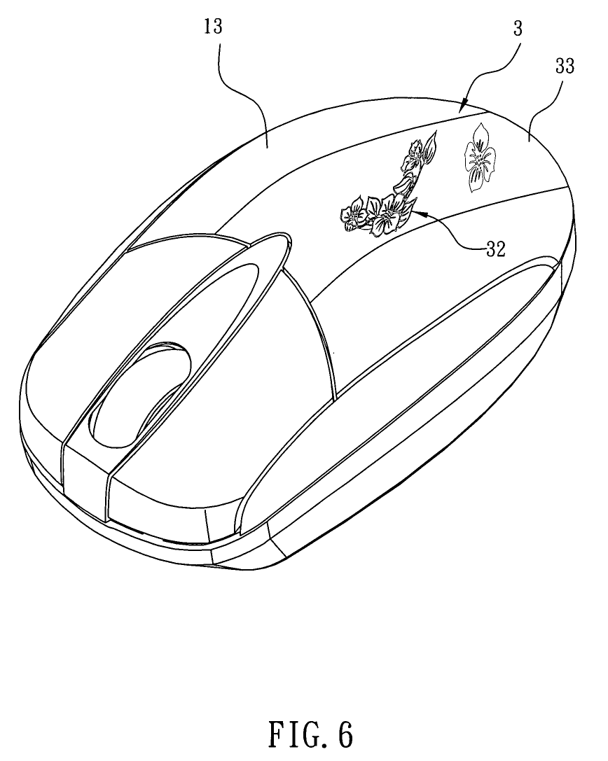

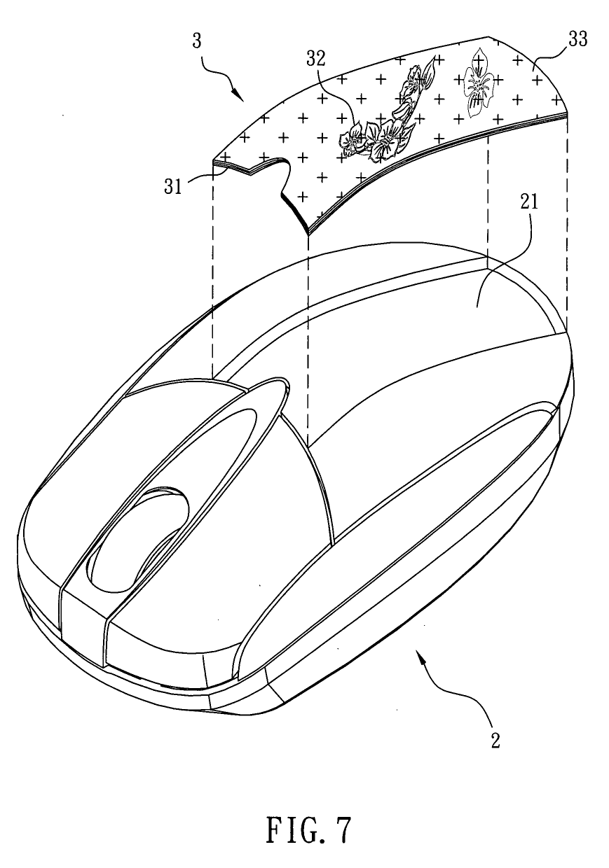

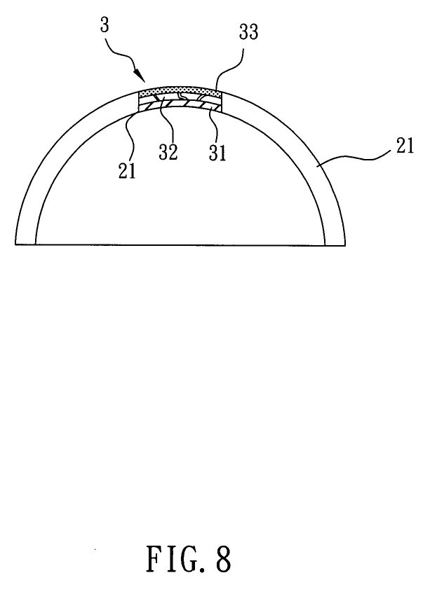

Please refer to FIG. 6 to FIG. 10, which are a perspective, an explosive and a sectional views showing a fourth preferred embodiment; and perspective views showing the fifth and the sixth preferred embodiments. As shown in the figures, the skin 3 for parallel device further comprises a shell 2.

The shell 2 is made of plastics and has a sunk area 21 on a surface.

The skin 3 for parallel device is put in the sunk area 21. The skin 3 for parallel device comprises a metal base layer 31; an image area 32 on a surface of the metal base layer 31; and a coating layer 33 cove red on the metal base layer 31 and the image area 32, where the image area 32 is flat or is 3D hollowed-out; and is deposed on a surface of the metal base layer 31. The coating layer 33 is made of a glass material and a metal oxide; the glass material is made by mixing with a borate or a silicate; and the glass material has more than 25% of boron oxide.

When fabricating, the shell 2 and the skin 3 for parallel device are separately made. On fabricating the shell 2, the shell 2 is formed into a requested figure having a sunk area 21.

On fabricating the skin 3 for parallel device, the metal base layer 31 is formed into the shape of the sunk area 21. The image area 32 is hollowed out with a copper wire or a wire of other metal; and the image area 32 designed by the wire is burnt at 900° C. to be firmly welded on the metal base layer 31. Then the glass material is filled into the hollowed-out image area 32 and is burnt at 750° C. to 800° C. to form a coating layer 33 above the metal base layer 31 and the image area 32. In the end, a polish is done as required

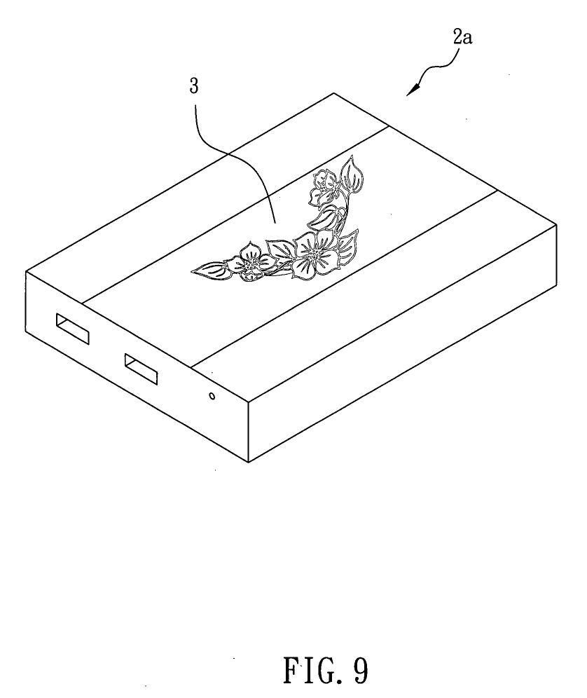

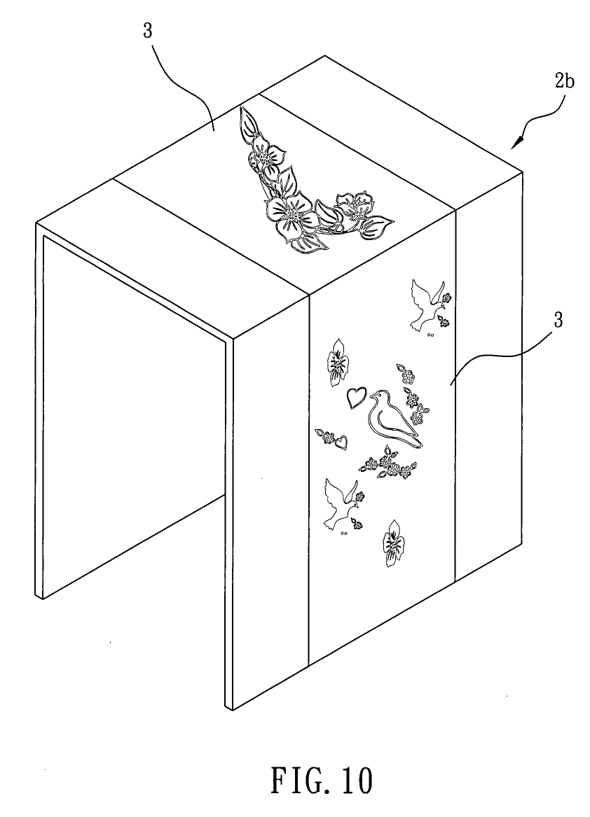

After the shell 12 and the skin 3 for parallel device are separately fabricated, the skin 3 is adhered in the sunk area 21. And the skin is not only for a mouse, but also for an external hard disk 2a (as shown in FIG. 9), a computer main frame 2b (as shown in FIG. 10), a USB (universal serial bus) hub, a network device and a DVD (digital versatile disc) player.

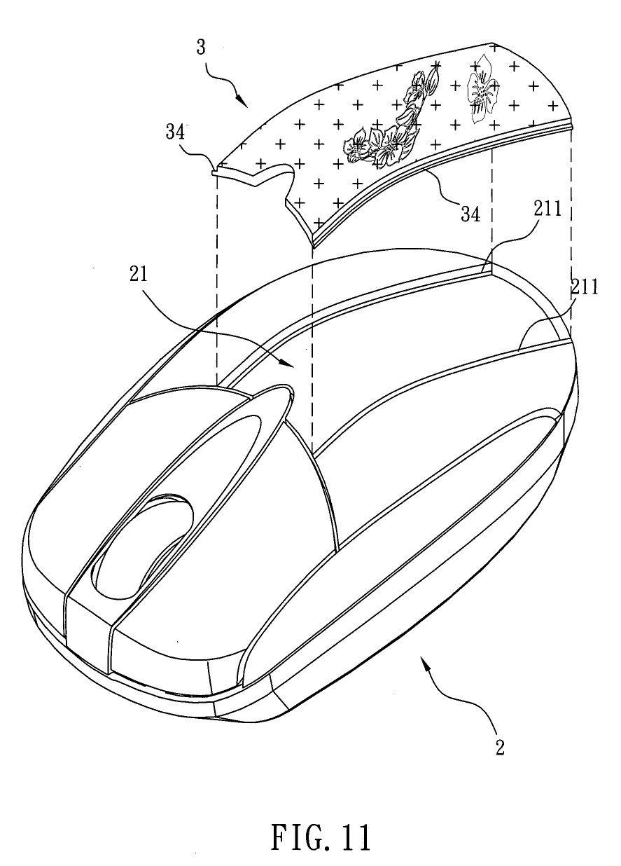

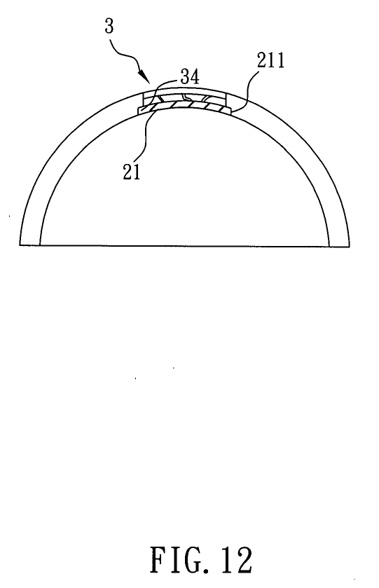

Please refer to FIG. 11 and FIG. 12, which are an explosive and a sectional views showing the seventh preferred embodiment. As shown in the figures, a sunk area 21 of a shell 2 has a concave 211 around on a border of the sunk area 21 to be locked with a convex 34 around on a border of a skin 3 for parallel device. Hence, the skin 3 for parallel device is locked in the sunk area 211 of the shell 2 by the concave 211 and the convex 34.

To sum up, the present invention is a skin having an enameled metal structure for parallel device, where a parallel device obtains a beautiful appearance and a sense of feel with the skin for parallel device; and the parallel device is thus prevented from scrape and corrosion and is easily cleaned.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A skin having an enameled metal structure for parallel device, comprising:
a metal base layer;
an image area, said image area being deposed on a surface of said metal base layer; and
a coating layer, said coating layer covered on said metal base layer and said image area, said coating layer being made of a glass material and a metal oxide.

2. The skin according to claim 1,
wherein said parallel device is selected from a group consisting of a mouse, an external hard disk, a computer mainframe, a USB (universal serial bus) hub, a network device and a DVD (digital versatile disc) player.

3. The skin according to claim 1,
wherein said image area is flat and is deposed on a surface of said metal base layer.

4. The skin according to claim 1,
wherein said image area is 3D (three-dimensional) hollowed-out and is deposed on a surface of said metal base layer.

5. The skin according to claim 1,
wherein said glass material of said coating layer is obtain by mixing with a salt selected from a group consisting of a borate and a silicate; and
wherein said glass material has boron oxide at a rate above 25 percents.

6. The skin according to claim 1,
wherein said coating layer is obtained by burning said glass material at a temperature between 750° C. and 800° C.

7. The skin according to claim 1
wherein said skin for parallel device further comprises a shell;
wherein said shell has a sunk area on a surface of s aid shell; and
wherein said skin for parallel device is deposed in said sunk area.

8. The skin according to claim 1,
wherein said shell is made of plastics.

9. The skin according to claim 1,
wherein said skin for parallel device is adhered in said sunk area.

10. The skin according to claim 1,
wherein said sunk area has a concave around on a border of said sunk area;
wherein said skin for parallel device has a convex around on a border of said skin for parallel device; and
wherein said sunk area and said skin for parallel device are locked to each other by said concave and said convex.
